(19) United States
(12) Patent Application Publication
(10) Pub. No.: US 2009/0108695 A1
(43) Pub. Date: Apr. 30, 2009

(54) Symmetrical Coil Electric Motor

(76) Inventor: Sean Scott, Crownsville, MD (US)

Correspondence Address: LAUBSCHER & LAUBSCHER, P.C., 1160 SPA ROAD, SUITE 2B, ANNAPOLIS, MD, 21403, US

(21) Appl. No.: 12/123,592

(22) Filed: May 20, 2008

Related U.S. Application Data
(60) Provisional application No. 60/939,137, filed on May 21, 2007.

(51) Int. Cl. H02K 3/28

(52) U.S. Cl. 310/208

(57) ABSTRACT

An electric motor includes symmetrical elliptical coils on the inner surface of the motor stator. The coils are formed of a conductive material having a rectangular cross section and the long axis of the coils is parallel to the longitudinal axis of the stator. Within the stator and coils is arranged a rotor coaxial with the stator and having permanent magnets connected with the rotor exterior surface. The symmetrical coils produce increased magnetic flux when energized as compared to random windings on a stator energized with the same current level to increase the torque produced by and the efficiency of the motor.

This application claims the benefit of U.S. provisional application No. 60/939,137 filed on May 21, 2007.

### BACKGROUND OF THE INVENTION

Brushless electric motors are well-known in the prior art. Such motors include a cylindrical stator having random coil windings of wire thereon and a rotor coaxially arranged within the stator. The rotor typically includes a plurality of permanent magnets. When a current passes through the windings, magnetic flux is generated. The flux interacts with the magnetic fields of the magnets on the rotor, causing the rotor to rotate relative to the stator. As the current in the windings increases, the magnetic flux increases and the rotor rotates faster to increase the torque of the motor.

There are size restraints on the size of the rotor, stator and windings of conventional brushless electric motors which limit their output and efficiency. The present invention relates to an improved brushless electric motor with unique symmetrical windings which produce greater magnetic flux when compared with similar sized motors operating at the same current levels to increase the torque generated by the motor.

### SUMMARY OF THE INVENTION

The electric motor according to the invention includes a hollow cylindrical stator including a longitudinal axis and a rotor coaxially arranged within the stator and adapted for rotation with respect thereto. A plurality of permanent magnets are connected with the exterior surface of the rotor and a plurality of symmetrical coils are connected with the inner surface of the stator. Each coil is formed of a conductor having a rectangular cross-sectional configuration which is wound in an elliptical configuration, the long axis of which is parallel to the axis of the stator. When current is applied to the coil conductors, a magnetic flux is generated which interacts with the magnetic fields of the magnets to cause the rotor to rotate.

In a preferred embodiment, the symmetrical coils are arranged in inner and outer layers on the stator surface, with the coils of each layer being spaced from the adjacent coil. Each coil of the inner layer overlaps adjoining coils of the outer layer of coils, so that the coils are staggered around the inner surface of the stator. An epoxy resin is arranged in the gaps or spaces between the adjacent coils.

In addition, the rotor and stator are both formed of laminated iron, and the magnets connected with the rotor are arranged with alternating polarity on the rotor surface.

### BRIEF DESCRIPTION OF THE FIGURES

Other objects and advantages of the invention will become apparent from a study of the following specification when viewed in the light of the accompanying drawing, in which:

FIG. 1 is a perspective cutaway view of the electric motor according to the invention;

FIG. 2 is a sectional view of the motor taken along line 2-2 of FIG. 1;

FIG. 3 is a perspective view of a symmetrical coil for the motor according to the invention;

FIG. 4 is a side plan view of a preferred configuration for the symmetrical coil; and

FIG. 5 is a partial sectional view of the coils of the invention showing the spaced arrangement of the coils within inner and outer layers.

### DETAILED DESCRIPTION

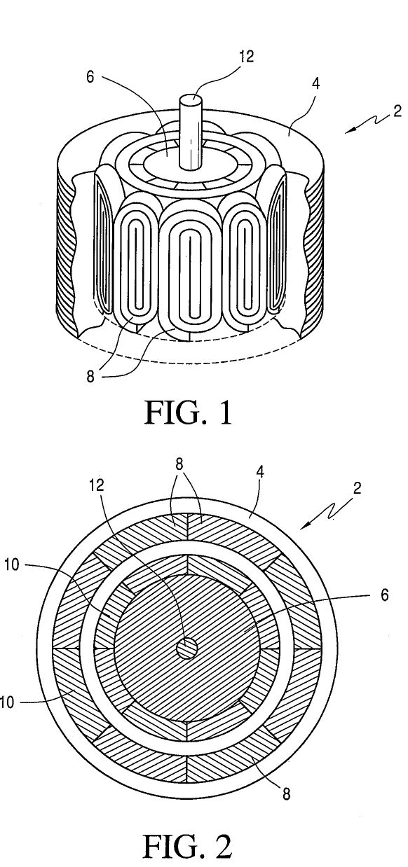

As shown in FIGS. 1 and 2, the electric motor 2 according to the invention includes a cylindrical stator 4 having a longitudinal axis and defining a chamber in which a cylindrical rotor 6 is arranged. The stator includes a plurality of symmetrical windings or coils 8 on the inner surface thereof as will be developed below, and the rotor includes a plurality of magnets 10 connected with the outer surface thereof, preferably in contiguous relation. At the center of the rotor is the output shaft 12 of the motor. The rotor and shaft are coaxial with the stator. The magnets are connected with the rotor in a conventional manner. Preferably, the magnets are polarized permanent magnets and the polarity of each successive magnet is reversed around the circumference of the rotor. Thus, each magnet produces a magnetic field which are alternately reversed about the rotor.

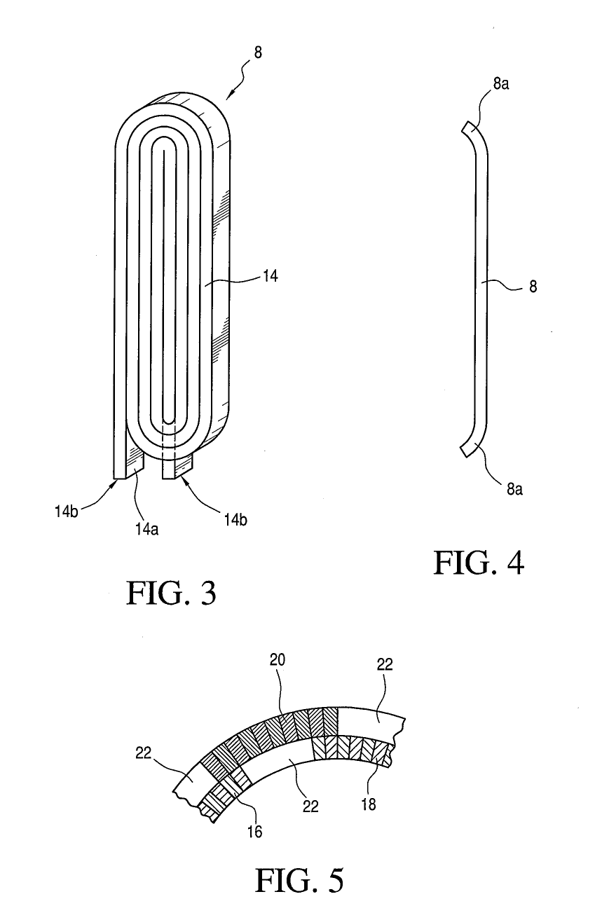

Referring now to FIG. 3, the coils according to the invention will be described. Each coil is formed of a conductor 14 wound with a jig into an elliptical configuration. The conductor is preferably a flat metal element such as copper having a rectangular cross-sectional configuration. The conductor is wound so that the flat portion 14a of the conductor is contiguous. The wound coils are pressed into an annular configuration to fit within the stator 4 with which each coil is connected in a conventional manner. The end portions 8a of each coil in the longitudinal direction may be bent as shown in FIG. 4 to fit snugly within a housing (not shown) for the motor.

A suitable conductor for the coils is copper. The ends 14b of the conductors of each winding are connected with a current supply (not shown) so that as current runs through each coil, magnetic flux is generated. The symmetrical coils increase the efficiency of the motor by allowing more copper to be present in each coil. The greater copper density and symmetrical shape of the coils increases the magnetic flux generated by the coils. The coils are operated pairs to produce magnetic fluxes of different direction. The interaction of the magnetic flux from the coils and the magnetic fields from the permanent magnets on the rotor causes the rotor to rotate about its axis, thereby rotating the shaft 12.

As shown more particularly in FIG. 5, the coils 8 are preferably arranged in inner and outer layers on the interior surface of the stator, with the coils of each layer being equally spaced from the next coil in the layer. Thus, coils 16 and 18 from inner layer of coils have a gap therebetween. Similar gaps are provided between successive coils of each layer. The coils of each layer are staggered relative to the coils of the other layer. That is, coils 16 and 18 of the inner layer of coils overlap the coil 20 of the outer layer of coils. The remaining coils of each layer are similarly arranged. The gaps between the coils are preferably filled with an epoxy resin 22. technique enhances the motor design by reducing the cost of manufacture. The stator and core laminations can be produced with a single stamp of a cutting die. When both pieces are utilized, the cost of the rotor core laminations is negligible and replaces the need for a sold iron core. Also, a laminated rotor core has better adherence to the shaft 12 since they are laminated directly to the surface of the shaft.

A solid rectangular shaped conductor increases the density of the coils and thus increases the amount of conductive material in the space provided for the coils. The additional density allows the radial axis of the motor to be reduced and improves the overall efficiency of the design. The torque is increased and the motor diameter is reduced. The reduction in diameter also increases the heat transferability and thus increases the longevity of the magnets and reduces wear on the motor.

While the preferred forms and embodiments of the invention have been illustrated and described, it will be apparent to those of ordinary skill in the art that various changes and modifications may be made without deviating from the inventive concepts set forth above.

What is claimed is:

1. An electric motor, comprising
(a) a cylindrical stator having a longitudinal axis and defining a chamber;
(b) a rotor arranged within said stator chamber coaxial with said stator and adapted for rotation with respect thereto;
(c) a plurality of magnets connected with an outer surface of said rotor; and
(d) a plurality of symmetrical coils connected with an inner surface of said stator, each of said coils comprising a conductor having a rectangular cross-sectional configuration and wound in an elliptical configuration, a long axis of each coil being parallel with the stator longitudinal axis, whereby when current is supplied to said coils, said coils produce a magnetic flux which acts on said magnets to cause said rotor to rotate with respect to said stator.

2. An electric motor as defined in claim 1, wherein said rotor is formed of laminated metal.

3. An electric motor as defined in claim 2, wherein said stator is formed of laminated metal.

4. An electric motor as defined in claim 2, wherein said coils are arranged in contiguous relation on said stator inner surface.

5. An electric motor as defined in claim 4, wherein said magnets are arranged in contiguous relation on said rotor outer surface.

6. An electric motor as defined in claim 5, wherein said magnets comprise permanent magnets arranged with alternating polarity on said rotor outer surface.

7. An electric motor as defined in claim 1, wherein said plurality of symmetrical coils comprises inner and outer layers of coils.

8. An electric motor as defined in claim 7, wherein said coils of each layer are spaced from each other.

9. An electric motor as defined in claim 8, wherein each coil of said inner layer of coils overlaps adjoining coils of said outer layer of coils.

10. An electric motor as defined in claim 9, wherein an epoxy resin material is arranged in the gaps between said coils of each layer of coils.
